(19) United States
(12) Patent Application Publication
(10) Pub. No.: US 2014/0292164 A1
(43) Pub. Date: Oct. 2, 2014

(54) SYSTEM FOR THE MODULAR CONSTRUCTION OF COUNTERS, MORE PARTICULARLY SALES COUNTERS

(71) Applicant: Franz Kallos, Warstein (DE)

(72) Inventor: Franz Kallos, Warstein (DE)

(73) Assignee: Vieler International GmbH & Co. KG, Iserlohn (DE)

(21) Appl. No.: 14/235,543

(22) PCT Filed: Jun. 22, 2012
(86) PCT No.: PCT/EP2012/002635

§ 371 Date: May 1, 2014

(30) Foreign Application Priority Data
Jul. 29, 2011 (EP) 110 06 248.6

(51) Int. Cl. A47B 96/14; F16B 12/02; A47F 3/00

(52) U.S. Cl. CPC A47B 96/1466; A47F 3/00; F16B 12/02
USPC 312/111

(57) ABSTRACT

A system for the modular construction of counters, including at least two modules. Arranged on each of the two sides of each module is a post, which is able to bear the components of the module, such as furniture elements and/or which defines the module. Each post has at least two part profiles, specifically one right and one left part profile. These can be co-located so as to create an optical unit. At their upper end, the part profiles can be fixed together via at least one upper closure. Various modules differing from each other in shape, size or ground area, have the same part profiles. All right and all left part profiles are structured identically to one another and are preferably installed mirror-inverted to one another. Hereby, each post in the system has the same thickness, regardless of the shape and size of the modules used.

The invention relates to a system for the modular construction of counters of the type mentioned in the preamble of Claim 1. Such counters are used particularly in the case of sales counters for food stuffs, as well as for other objects. Today it is common to construct such counters as so-called counter landscapes in which several such counters are arranged next to one another. These elements may have different shapes and dimensions. In such counter landscapes it is important that they present a uniform image; in addition, it should be possible to also arrange the landscapes differently and to arrange and/or expand them depending upon the wishes of the user.

DE 299 18 469 U 1 describes a device for the releasable frictional engagement of counter support columns for sales counters. For this purpose, each counter element includes a counter support column. In that case, a profile rail is placed in a positively locking manner over two adjacent counter support columns in order to connect them to each other.

However, this device makes it only possible to arrange several sales counter elements in a row next to one another if they have a rectangular base area. It is also not intended to provide counter elements which do not have a rectangular base area. Also, it is not possible to combine different types or shapes of counter modules with each other. Moreover, the counter support column is optically unpleasant since it hinders or even prevents the free view of the various counter elements and the goods exhibited therein.

Document DE 187 03 385 C1 shows a counter for goods. Also in the document described here, it is possible to connect several counters to each other by joining two core sections to a double core section which then is surrounded by a common enveloping section. This causes significantly thicker sectional elements, which also is optically unpleasant. Moreover, it is also here not possible to combine differently shaped counter elements, particularly counter elements without rectangular base areas, with each other as desired.

It is, therefore, an object of the invention to provide a system for the modular construction of counters which avoids the above mentioned disadvantages and which makes it possible, in a simple and inexpensive manner, to combine differently shaped counter modules. This object is met by the characterizing features of Claim 1 which have the special following significance.

Each post consists of at least two partial sections, namely a right and a left partial section, which can be joined together and form an optical unit as a result. At their upper ends the two partial sections are secured together through at least one upper closure. All right and left partial sections are identical to each other and each post of the system has the same thickness, independently of shape and size of the modules used. The modules can be of the most varied shape or base area Independently of the shape, size or base area of the various modules, the same partial sections are used. Accordingly, the system constructed according to the invention presents a unitary image. It is particularly advantageous if all partial sections used are mounted in a mirror inverted manner to each other for forming the right and left partial sections.

It is particularly advantageous to construct the upper closure as a cap. This cap can them cover both partial sections over the entire cross section thereof. For example, contamination and foreign bodies cannot enter the partial sections. The cap can include engagement means for engagement with one or more structural parts of each of the two partial sections. Additionally or alternatively, fastening means can be mounted on the cap for connection with one or more receiving means of each of the two partial sections. For example, the cap can be mounted securely, and still releasably, on the partial sections. In addition, a cap can be provided with one or more ornamental elements, depending on the desired optical configuration of the counter.

Preferably, the upper closure includes at least one upper hinge element, such as a pin or a bushing. In addition, a door is provided which includes an upper counter hinge element, such as a bushing or a pin. The upper hinge element and the upper counter hinge element can be placed in an operative connection in order to form an upper hinge on which the door is pivotally hinged in the upper area of the module.

In accordance with a preferred embodiment, each partial section has at its lower end a lower half closure in the form of a half rosette. This half rosette is arranged optionally at a main body of the module or on a floor on which the counter is arranged. In the mounted state, the two half rosettes form a full rosette. This is advantageous because automatically the impression of a complete structural component is created in the mounted state, namely that of a post which is composed of the two partial sections.

Moreover, a lower hinge element, such as a pin or bushing, is arranged on at least one of the two half rosettes, wherein also in this case a door is provided which includes a lower counter hinge element, such as a bushing or a pin. The lower hinge element and the lower counter hinge element can be placed in operative engagement with each other in order to form a lower hinge through which the door is pivotally hinged in the lower area of the module.

If an upper and a lower hinge are provided as described above, the module door is effectively arranged only at a partial section of the module. In order to increase the exchangeability and modularity of the total system, appropriate doors are hinged only to a left partial section or only to the right partial section. Of course, a mixed arrangement of hinged connections of doors to the modules is conceivable, however a portion of the flexibility and modularity is lost as a result.

The only difference in differently shaped modules, particularly in the case of using rectangular and nonrectangular modules, resides in the fact that in the case of using doors, the upper and lower hinge elements are arranged at the upper closure or at the lower half closure at different locations in relation to the contact area of the two partial sections for covering the different angle conditions of the individual modules. However, this does not influence the configuration of the respective partial section, which is constructed identically, to all other partial sections. As a result, significant savings are effected. Of course, the doors can have different sizes in order to adapt them to the size of the respective module.

The partial sections preferably consist of continuously cast aluminum profiles. Other materials and methods of manufacture are also conceivable. As a result of a manufacture of identical right and left partial sections, significant costs are saved because the partial sections can be manufactured in larger numbers and more tools are not required for the manufacture of partial sections. The cost for storing the partial sections is also reduced.

Further advantageous embodiments of the invention result from the dependent Claims of the following description and the drawings. In the drawings, the invention is illustrated in an embodiment. In the drawings:

FIG. 1 shows a counter according to the invention as seen from the side of the customer,

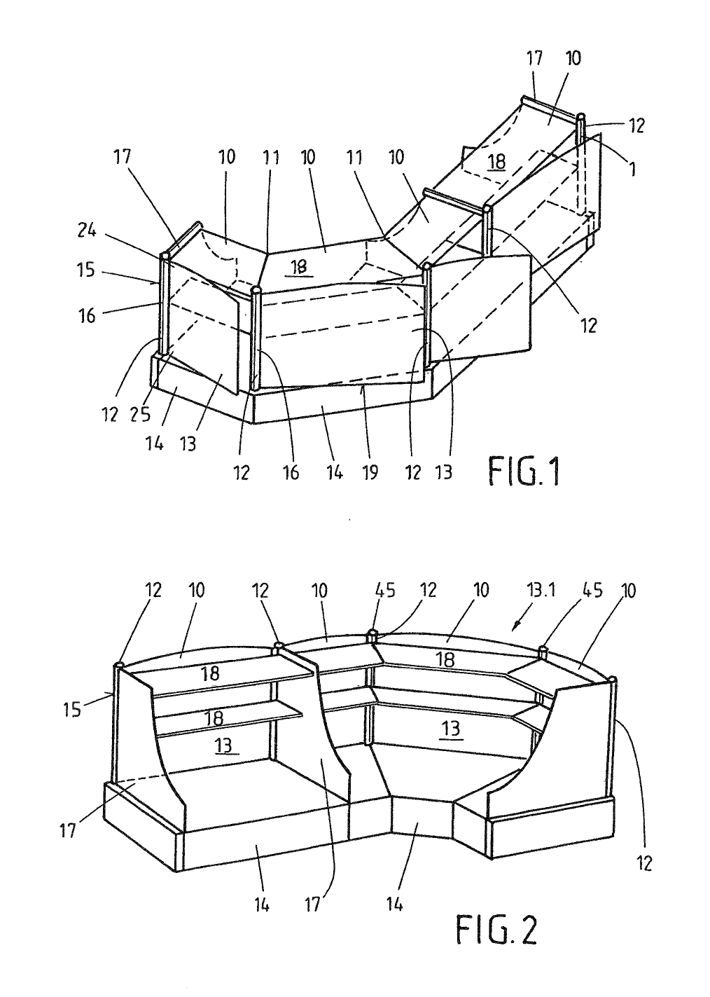

FIG. 2 shows the counter of FIG. 1 as seen from the operator side,

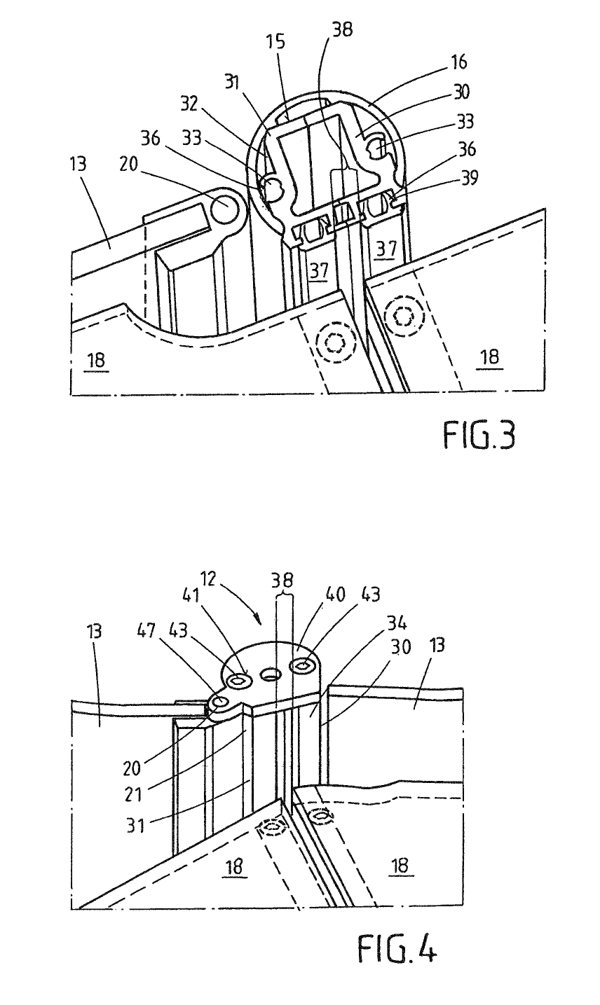

FIG. 3 shows the construction of a post according the invention without the upper closure with rectangular modules,

FIG. 4 shows the post with upper closure in the case of nonrectangular modules,

FIG. 5 shows a post of a last module of the counter,

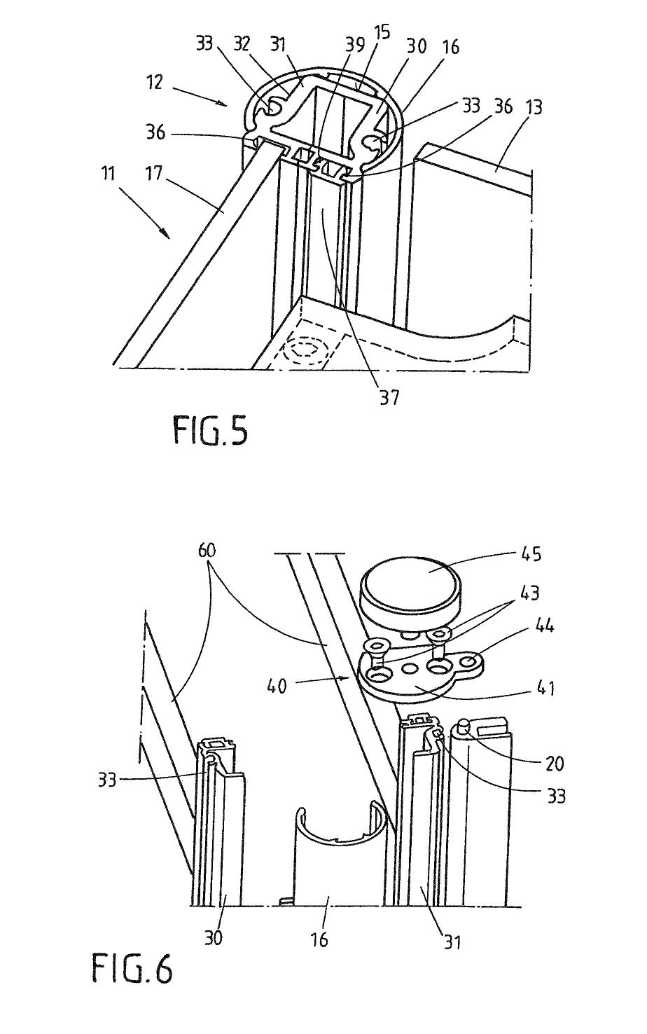

FIG. 6 shows the structural components of the post with upper closure in an exploded view,

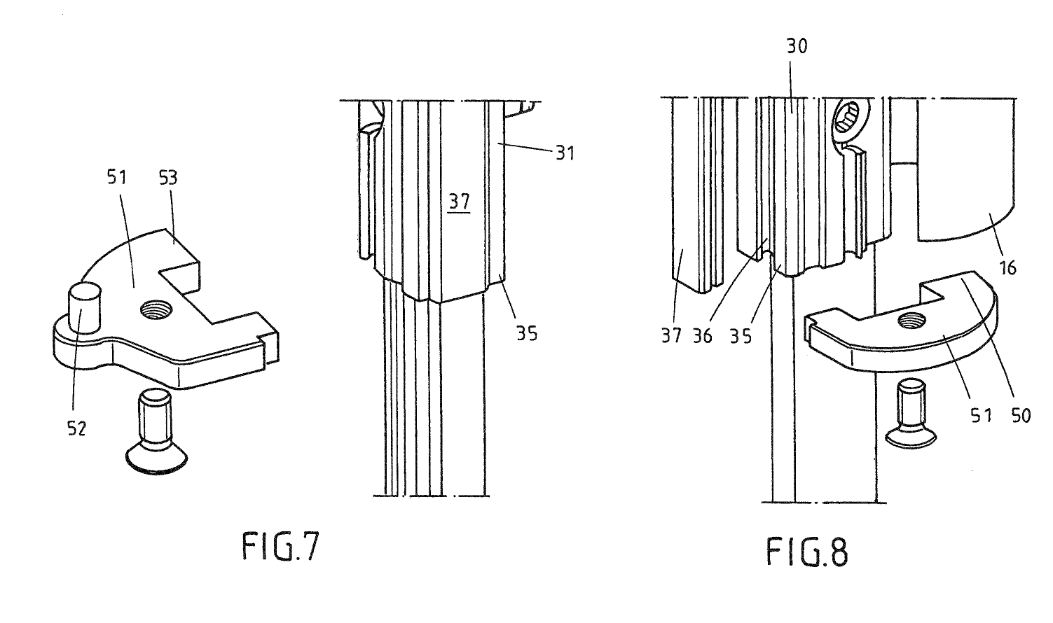

FIG. 7 shows a lower half closure of a left partial section,

FIG. 8 shows a lower half section of a right partial section,

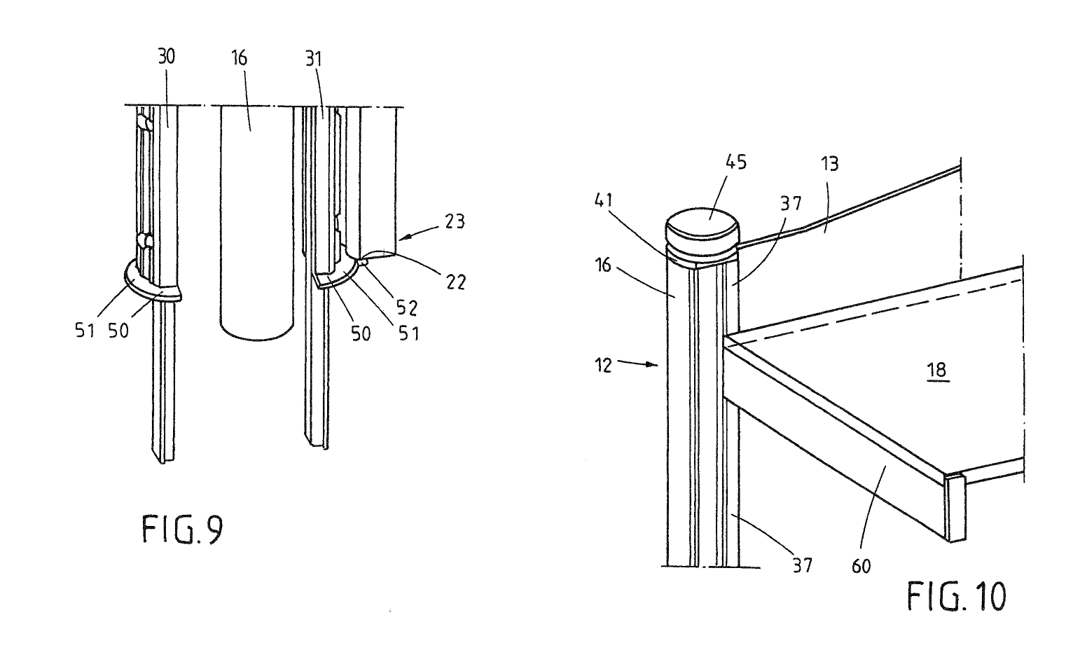

FIG. 9 shows the lower structural components of the post in a pulled apart view,

FIG. 10 shows a post of a last module with an intermediate carrier,

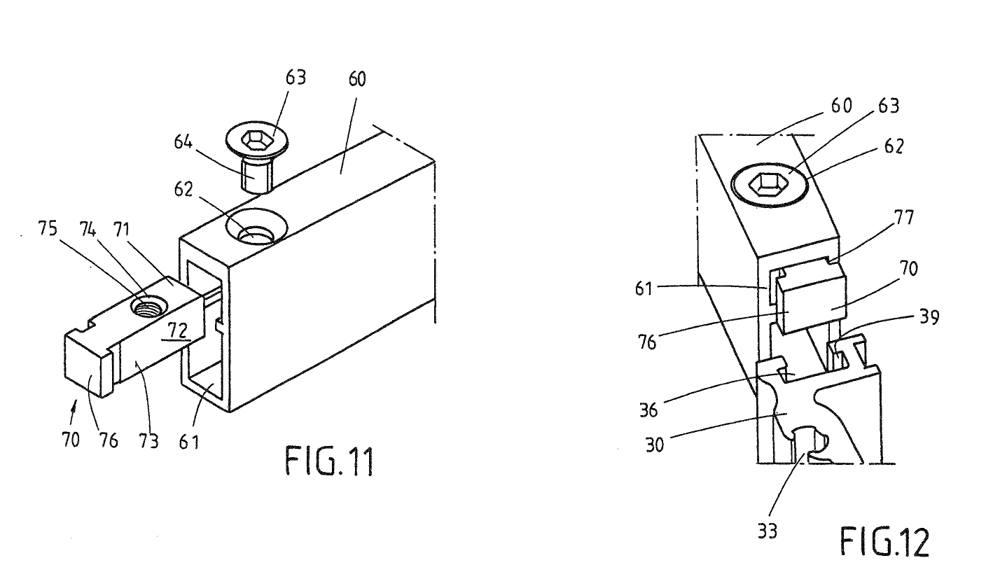

FIG. 11 shows the structural components of the intermediate carrier with a clamping holder,

FIG. 12 shows the intermediate carrier with clamping holder and partial section,

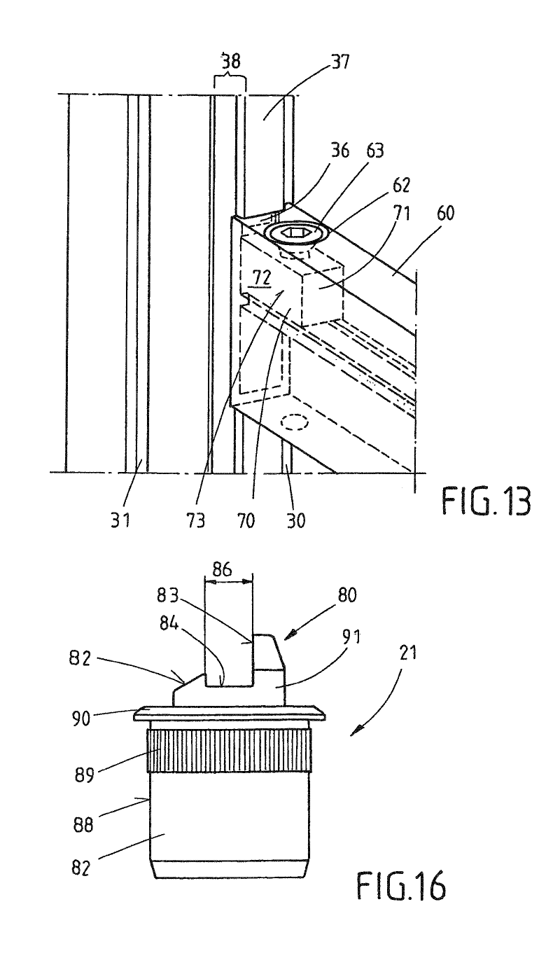

FIG. 13 shows the intermediate carrier fastened to the partial section,

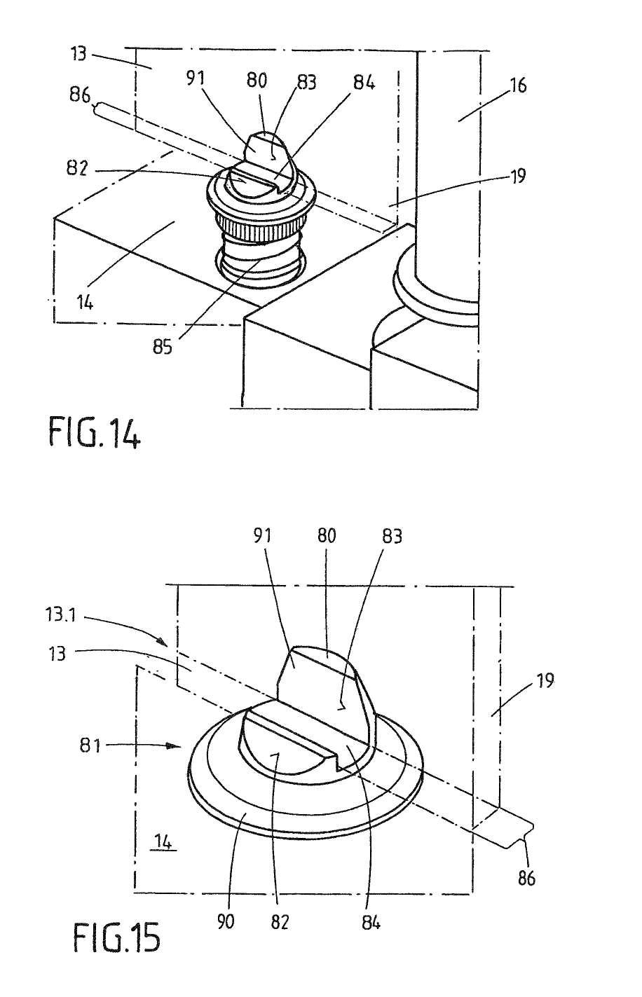

FIG. 14 shows the construction of a stop constructed as a stop button,

FIG. 15 shows the stop button in the mounted state,

FIG. 16 shows the stop button separately in a side view.

FIGS. 1 and 2 show a counter landscape constructed in accordance with the system of the invention. The counter landscape comprises four modules 10 which are constructed differently with respect to shape, size and base area. Each module 10 has a door 13. The body or corpus 14 of each module is arranged in the area of the bottom or the support surface. All structural components, except for the post 12 protruding thereabove, consist of transparent material, for example, glass. Of course, other materials are also conceivable. Each module 10 comprises several furniture elements 18, in the present case a payment plate and a shelf bottom. Of course, other shapes of furniture elements are also conceivable. In FIG. 1, the doors 13 of the modules 10 are open, while they are shown in their end position 13.1 in FIG. 2.

In can further be seen that a separating pane 17 is arranged between two modules 10 and respectively at the end of the counter landscape at the two last modules 10. Whether and if several separating panes 17 are arranged in the counter landscape, depends on the respective case of application and is subject predominantly to the requirements of the total optical impression.

The construction of a post 12 is shown in FIG. 3. It can be seen that the right partial section 30 and the left partial section 31 are mounted identically relative to each other, but in a mirror inverted manner. The partial sections 30, 31 contact each other in their contact areas 38 and together form an optically attractive and unitary total overall impression. A lining 16 is provided at the outer side 15 of the post 12 over approximately three quarters of the circumferential surface of the lining 16. The lining 16 has here a partial circular cross section. However, other shapes of the lining 16 are also conceivable. The material of the lining 16 can also vary. For example, this can also be a continuously cast aluminum section, or a section of other materials, or a section of synthetic materials or composite materials, etc. The outer surface of the lining 16 depends only on the desired optical total impression of the counter. A plurality of colors, surfaces and shapes are conceivable in this connection. In this embodiment, the lining 16 is clipped to the post 12.

It can additionally be seen that the door 13 comprises an upper counter hinge element 20, here a bushing. The more precise construction of the door 13, and of the hinges 21, 23, will be explained later.

Moreover, it can further be seen that the two partial sections 30, 31 each comprise a respective sectional groove 36. This sectional groove is at least partially undercut 39, here completely. The sectional groove 36 is covered by a cover section 37 in order to protect it against contamination and to improve the total optical impression of the post 12 as an interconnected structural component.

Furthermore, the two receiving means 33 are shown which are arranged in each of the two partial sections 30, 31. The precise use is apparent from FIG. 4.

In FIG. 4 it is once again shown that a post 12 is provided, however, this time with an upper closure 40. In the upper closure 40 two fastening means 43 are introduced, in this case screws. These screws engage in the receiving means 33 shown in FIG. 3 and in the right partial section 30 and in the left partial section 31. Consequently, the partial sections 30, 31 are securely held together by the upper closure 40 constructed as a cap 41 with the intermediate arrangement of the fastening means 43, in order to form the post 12.

Furthermore, it can be seen that contrary to the area shown in FIG. 3, in FIG. 4 the two modules 10 are not rectangular with respect to their base area. Nevertheless, the post 12 with the two partial sections 30, 31 is still constructed identically to that in FIG. 3. The only difference between the two posts 12 of FIGS. 3 and 4 resides in the arrangement of the hinges 21, 23 for the door 13. As illustrated in FIG. 4, an upper hinge element 44, here a bushing, is arranged at the cap 41, while the door 13 comprises an upper counter hinge element 20, here a pin, wherein the upper hinge element 44 forms, with the upper counter hinge element 20, the upper hinge 21. The door 13 is hinged in the upper area 24 of the module 10 by the hinge 21.

If now the position of the upper hinge element 44 from FIG. 4 is compared to the position of the upper counter hinge element 20 from FIG. 3, it becomes apparent that the upper hinge 21 is located at a different location in relation to the post 12. This is due to the fact that the two modules 10 shown in FIG. 3 have rectangular base areas, while the two modules 10 of FIG. 4 do not have rectangular base areas. However, in order to be able to use identical partial sections 30, 31 and identical doors 13, only the shape of the upper closure 40 is changed in such a way that the upper hinge 21 is arranged at a different location. This makes it possible to use the maximum flexibility and modularity of the present system and moreover, to save costs since many components are identical to each other.

FIG. 5 now shows a post 12 without upper closure 40 at a last module 10 of a counter landscape. This post 12 also has two partial sections 30, 31 which are assembled in the already known and described manner. A lining 17 is also provided for covering the post 12 at its outer side 15. In addition, the two partial sections 30, 31 have sectional grooves 36, as already known. However, while one sectional groove 36 has a cover section 37, a separating pane 17 is mounted in the other sectional groove 36.

If the separating pane 17 is arranged between two modules 10, it can be mounted at the same location in the sectional groove 36, or also in the contact area 38 of the two partial sections 30, 31. In that case, both sectional grooves 36 can be equipped with appropriate cover sections 37.

FIG. 6 shows an overview of the generally used structural components of a post 12 or of two modules 10. Two partial sections 30, 31 are provided which together form the post 12. In addition, there is the upper closure 40 which ensures that the two partial sections 30, 31 are held together. This is effected by two fastening means 43, here as screws. Moreover, an upper hinge element 44 and an upper counter hinge element 20 are provided for forming an upper hinge 21 on which the door 13 is pivotally mounted. Moreover, on each of the two partial sections 30, 31 an intermediate carrier 60 is additionally provided, on which a furniture element 18 can be arranged. The upper closure 40 can be equipped with an ornamental element 45 in order to achieve the desired optical total impression of the module 10 or to provide a decoration. Thus, the right partial section 30 belongs to a first module 10, while the left partial section 31 already belongs to a second module 10. If both partial sections 30, 31 are connected to a post 12, the two modules 10 form a part of the desired counter landscape. Furthermore, the post 12 can already be provided with the lining 16 in the area of its outer side 15,

The construction of the lower half closures 50 at the two partial sections 30, 31 are illustrated in FIGS. 7 and 8. Each of the two lower closures 50 is constructed as a half rosette 51. Each half rosette 51 is arranged at the lower end 35 of the respective partial section 30, 31, and is fastened there, for example, by means of a screw. Other types of fastening such as a clip connection, rivets, welding or similar connections are of course also conceivable. If the two partial sections 30, 31 are moved together, the two half rosettes 51 form a full rosette, so that an advantageous optical total impression of the post results,

In the area of the left lower half closure 50, a lower hinge element 52 is provided, here a pin. As can be seen from FIG. 9, a lower counter hinge element 22, in this case a bushing, is arranged at the corresponding door 13. The lower hinge element 52 and the lower counter hinge element 22 together form a lower hinge 23 to which the door 13 is pivotally movably attached. In total, it is advantageous for the modularity and compatibility of the system if the hinges 21, 23 are arranged only on one type of partial section 31, 31, i.e. only on the right partial section 30 or on the left partial section 31.

FIGS. 10 through 13 show the way in which the intermediate carrier 60 can be attached and fastened to a partial section 30, 31. The intermediate carriers 60 have the purpose of serving to support a furniture element 18, such as a shelf floor, a counter plate or the like. For this purpose, each intermediate carrier 60 can be supported by a clamping holder 70, particularly at the undercut 39 sectional groove 36 of a partial section 30, 31. As can be seen from FIG. 11, the intermediate carrier 60 has an opening 61 into which a clamping holder 70 can be inserted with one end 71 thereof. At the outer side 72 of the clamping holder 70 a guide surface 73 is provided in the area of its one end 71 which interacts with the opening 61 in the intermediate carrier 60 during insertion of the clamping holder 70.

The clamping holder 70 has a first recess 74 which is provided with a thread 75. This first recess 74 is located at the one end 71 of the clamping holder 70. In the area of its opening 61, the intermediate carrier 60 has a second recess 62. If the clamping holder 70 is inserted into the opening 61 of the intermediate carrier 60, the first recess 74 is arranged slightly eccentrically relative to the second recess 62. The other end 76 of the clamping holder 70 is constructed undercut and can be introduced into the sectional groove 36 of a partial section 30, 31. The undercut area 77 of the clamping holder 70 is, in this case, supportable in the undercut area 39 of the sectional groove 36.

A threaded bolt 63, in the present case a screw which has a second thread 64, can then be guided through the second recess 62 and placed into engagement with its thread 64 with the first thread 75 in the first recess 74 in the clamping holder 70. If this is done, the other end 76 of the clamping holder 70 is clamped in the sectional groove 36 of the partial section 30, 31, preferably with the intermediate arrangement of the intermediate carrier 60. This results in the situation illustrated in FIG. 13. The areas of the sectional groove 36 which are not occupied by the clamping holder 70 can themselves in turn be provided with appropriate cover sections 37 in order to provide a total unitary optical impression.

If a door 13 is used in the module 10 it should be ensured that the door 13 is secured in a defined end position 13.1, particularly when using the counter system in a store using counters or the like. As a result, accidents or damage to the goods in the module 13, due to unintentionally pivoting doors 13, is avoided. In order to hold the door 13 in a defined end position 13.1, a stop 80 is provided. Preferably, the door 13 is a transparent door 13, for example, a glass door.

In order to design the stop 80 securely and well, the stop 80 is constructed as a stop button 81. Moreover, an inclined surface 82 is provided which can be guided over the door 13 when it is guided into its end position 13.1. The head 91 of the stop button 80 thereby yields to the lower end 19 of the door 13. Moreover, the stop button 81 includes a door contact surface 83 against which the door 13 comes into contact in its end position 13.1 over a contact surface. In addition, a door support 84 is provided which preferably is located in a groove 86 in the head 91 and at which the lower end 19 of the door 13 is arranged, if the latter is in its end position 13.1. The stop button 81 is spring loaded 85, wherein the spring 85 biases the stop button 81 with its door support 84 against the lower end 19 of the door 13. In order to then move the door 13 out of its end position 13.1, the stop button 81 must be manually actuated against the force of the spring 85 in order to prevent an accidental opening of the door 13 if a person accidently bumps against the door 13.

As can be seen particularly from FIG. 16, the stop button 81 comprises a housing 87 by means of which it is mounted on a corpus 14 of the module 10. At its outer circumferential area 88, the housing 87 has a knurling 89 which ensures a secure and non-rotatable seat of the housing 87 in the corpus 14. This knurling can be arranged simply and inexpensively at the housing 87. It moreover ensures that the housing 87 is securely seated in the corpus 14 and cannot accidently slide out. Preferably, a plate 90 is provided at the housing 87 which serves as an upper support surface of the housing 87 on the corpus 14.

It is particularly preferred to arrange the head 91 and the stop 80 so as to be rotatable in the housing 87. If the door 13 is then moved into its end position 13.1, the stop 80 or the head 91 is aligned with its door contact surface 83 in such a way that the door 13 comes to rest in its end position 131 over a surface area 83.

It shall be pointed out that the embodiments of the invention are merely realizations of the invention serving as examples. The invention is not limited to these realizations. Rather, further changes and modifications are possible. Thus, the shape of the partial sections may be different. Also, the modules do not have to have a rectangular floor area, also other shapes particularly polygonal shapes, such as pentagonal or hexagonal are possible.

### LIST OF REFERENCE NUMERALS

10 module

11 side of 10

12 post

13 door

13.1 end position of 13

14 corpus of 10

15 outer side of 12

16 lining

17 separating pane

18 furniture element

19 lower end of 13

20 upper counter hinge element

21 upper hinge

22 lower counter hinge element

23 lower hinge

24 upper area of 10

25 lower area of 10

30 right partial section

31 left partial section

32 sectional component of 30, 31

33 receiving means

34 upper end of 30, 31

35 lower end of 30, 31

36 sectional groove

37 cover section

38 contact are of 30, 31

39 undercut area of 36

40 upper closure

41 cap

43 fastening means

44 upper hinge element

45 ornamental element

50 lower half closure

51 half rosette

52 lower hinge element

60 intermediate carrier

61 opening in 60

62 second recess

63 threaded bolt

64 second thread at 63

70 clamping holder

71 one end of 70

72 outer side of 70

73 guide surface

74 first recess

75 first thread at 74

76 other end of 70

77 undercut area of 70

80 stop

81 stop button

82 inclined surface

83 door stop surface

84 door support

85 spring

86 groove

87 housing

88 circumferential area of 87

89 knurling

90 plate

91 head of 81

1-14. (canceled)

15. A system for modular construction of counters, comprising: at least two modules; and a post arranged at both sides of each module, the post supporting structural components of the module and/or defines the module,
wherein each post has at least two partial sections including a right partial section and a left partial section that can be joined to form an optical unit,
wherein the partial sections are fastenable to each other at upper ends by at least one upper closure, wherein
different modules with respect to shape, size or base area have the same partial sections,
and wherein all right partial sections and all left partial sections are identical and are mounted in a mirror inverted manner, wherein each post in the system has the same thickness, independently of shape and size of the modules.

16. The system according to claim 15, wherein the upper closure is a cap on which are arranged engagement elements that are engageable with at least one structural component of each of the two partial sections and/or on which fastening elements are arrangable which are placeable in operative connection with at least one receiving element of each of the two partial sections, wherein the upper closure further includes at least one ornamental element.

17. The system according to claim 15, wherein the upper closure has at least one upper hinge element, and further comprising a door that has an upper counter hinge element, wherein the upper hinge element and the upper counter hinge element are placed in operative connection to form an upper hinge and thereby arrange the door pivotally in an upper area of the module.

18. The system according to claim 17, wherein each partial section has a lower end with a lower half closure formed as a half rosette that is fastenable to a corpus of the module or on a floor,
wherein the two half rosettes form a full rosette in a mounted state, wherein at least one of the half rosettes is provided with a lower hinge element, and further comprising a door that has a lower counter hinge element, and wherein the lower hinge element and the lower counter hinge element are placed in operative connection to form a lower hinge and to pivotally arrange the door in a lower area of the module.

19. The system according to claim 18, wherein the upper hinge elements and the lower hinge elements are arranged at the upper closure or the lower half closure at different locations in relation to the post, depending on the shape of the module.

20. The system according to claim 15, wherein the partial sections each have a sectional groove that is at least partially closeable with a cover section.

21. The system according to claim 15, wherein at each of the partial sections at least one intermediate carrier is arranged on which a furniture element is supportable, wherein the intermediate carrier is fastened by clamping holders at the partial sections in an undercut sectional groove.

22. The system according to claim 21, wherein each clamping holder is inserted with one end in an opening of the intermediate carrier, wherein an outer side of the clamping holder acts in an area of the one end at least partially as a guide surface, wherein the clamping holder has a first recess with at least one thread, and the intermediate carrier has in an area of the opening a second recess, wherein the first recess is arranged eccentrically relative to the second recess,
wherein the clamping holder is introducable with its other end in a sectional groove of the partial section, wherein the other end of the clamping holder is undercut so that the other end is fastened in the undercut area of the sectional groove of the partial section,
wherein a threaded bolt, with a second thread is guided through the second recess and guided with its thread so as to be in engagement with the first thread in the first recess, wherein the other end of the clamping holder clamps in the sectional groove with intermediate arrangement of the intermediate support.

23. The system according to claim 15, wherein the module has a door, and a stop is provided for holding the door in a defined end position.

24. The system according to claim 23, wherein the stop is a stop button which comprises an inclined surface over which the door guides into the end position, the stop button further comprising a door contact surface that contacts with the door in the end position, and a door support that is located in a groove in a head of the stop and at which a lower end of the door is arranged in the end position,
wherein the stop head is spring loaded so that the stop button is biased with the door support against the lower end of the door,
wherein the door is moveable out of the end position only by manual actuation of the stop button against the spring force.

25. The system according to claim 24, wherein the stop button has a housing by which the stop button is arranged in a corpus of the module, wherein the housing has a circumferential area with a knurling that provides for a secure seat of the housing in the corpus and the housing has an additional plate that forms an upper contact surface of the housing against the corpus.

26. The system according to claim 25, wherein the stop or the head is rotatably mounted in the corpus or in the housing and aligns automatically so that the door in the end position rests evenly at the door contact surface.

27. The system according to claim 15, wherein each of the posts is covered at least on an outer side with a lining.

28. The system according to claim 15, further comprising a separating pane placed between two modules and/or at a last module of the counter, the separating pane being arrangable in an area of the partial sections as well as in an area of a sectional groove of a partial section.
